(19) United States
(12) Patent Application Publication
(10) Pub. No.: US 2008/0285482 A1
(43) Pub. Date: Nov. 20, 2008

(54) Quality of Service in Networked Computing Devices

(75) Inventor: Nadeem Wahid, London (GB)

Correspondence Address: FOX ROTHSCHILD LLP, P O BOX 592, 112 NASSAU STREET, PRINCETON, NJ, 08542-0592, US

(73) Assignee: SYMBIAN SOFTWARE LTD., London (GB)

(21) Appl. No.: 11/910,821

(22) PCT Filed: Apr. 7, 2006
(86) PCT No.: PCT/GB2006/001284

§ 371 Date: Apr. 30, 2008

(30) Foreign Application Priority Data
Apr. 7, 2005 (GB) GB0507104.8

(51) Int. Cl. H04L 12/28; H04Q 7/24

(52) U.S. Cl. 370/254; 370/338

(57) ABSTRACT

In mobile phones, delays can occur when the parameters that determine the characteristics of the network connection are changed or updated. The present invention sets the characteristics of the network connection in advance by anticipating the likely future use for network connections by analysing common or past usage. In a preferred embodiment the required network connection characteristics are triggered automatically by the opening of specific applications or a communication channel directed to a particular network address, or the use of specific bookmarks or Favourites.

The present invention relates to improving the quality of service for accessing networks with a computing device, and in particular to a method of reducing the latency and improving the responsiveness of a computing device which accesses wireless networks, and especially 3G wireless networks.

In the context of networked computing devices, the term Quality of Service (QoS) is used to denote the ability of the network to guarantee delivery of data within a specific timeframe. There are four main elements which go to make up QoS:
Availability: the ability of the network to provide continuous service
Bandwidth: also known as throughput, this refers to the quantity of data which the network can deliver in a period of time
Integrity: the ability of the network to deliver uncorrupted data with no errors.
Latency: the time taken by the network to respond to a request.

These elements are largely independent of each other.

This invention is concerned principally with the last element above, and in particular with improving the latency experienced in opening up network connections in advanced wireless telephone networks, such as those specified by the internationals standards body Third Generation Partnership Project (3GPP), now commonly known as 3G. The relevant specifications devised by this international standards body can be found at http://www.3gpp.org. An alternative set of specifications for 3G wireless networks has been devised by the Third Generation Partnership Project 2 (3GPP2) and can be found at http://www.3gpp2.org.

While the present invention is described in this document in terms of devices attached to 3GPP networks, it is to be understood that this is for the purposes of clarity only and is not intended to restrict the applicability of this invention to other types of networks. It is pointed out specifically that the present invention can be applied beneficially to any form of computing device attached to any form of network, including both 3GPP and 3GPP2 compliant wireless networks, and also wired networks.

A computing device attached to a wireless communications network is known in this art as a Mobile Station (MS). While mobile telephones and portable notebook type computers currently comprise the most numerous and most commonly used of these devices, they are not the only type of mobile station. Device convergence means that not only these devices, but also personal digital assistants (PDAs), game consoles, music players (such as MP3 players) and video players (such as DVD players) are increasingly becoming equipped with the facility to access wireless communication networks. This convergence is not unexpected, because 3G wireless networks are specifically aimed at providing fast data access, which facilitates the streaming of music and video to devices, and enables the predictable real-time performance required for modern interactive gaming.

In the network configurations of interest, a Mobile Station which is connected to a particular service on the network (such as Internet or WAP) is allowed to maintain multiple data streams in relation to that service. Each of these data streams can be specified as requiring a different QoS. For example, a single Mobile Station may be simultaneously maintaining a video stream that requires a high bandwidth and high quality continuous service in combination with a lower priority data stream dedicated to background downloading of e-mail, which needs no more than a ‘best effort’ service.

In the 3GPP specifications, a data stream opened by an application is called a Secondary PDP Context (where PDP is an acronym for Packet Data Protocol.) These secondary PDP Contexts represent standard network connections and as such may, in turn, carry multiple IP (Internet Protocol) data flows. Each IP data flow represents a socket opened by the application for communication to a remote host.

A problem addressed by this invention is that latency delays can occur when the nature of this network communication requires a renegotiation of the parameters that determine the characteristics of the network connection. Good examples of this are the latency delays that can occur when managing secondary PDP contexts on certain 3G data network configurations.

Typically, these delays arise when a new socket is opened by an existing application. When this occurs, the new socket has to be assigned to the existing Secondary PDP Context which has already opened by the application, and this assignment requires a modification of the specification maintained by the network describing the IP flows associated with the particular Secondary PDP Context. This specification is called a Traffic Flow Template (TFT), the format of which is described in section 15.3 of the 3GPP document TS 23.060, which is available at the 3GPP web site referred to above.

The 3GPP standards state that for each new socket opened, the Mobile Station should communicate an updated TFT to the network, which includes the new IP flow that needs to be associated with the chosen Secondary PDP Context. This specification is in terms of IP packet fields, such as address, port, protocol type (e.g. UDP or TCP) and so forth. These requirements are known to persons familiar with this art.

The time taken for this signaling exchange between the Mobile Station and the network is indeterminate, but can be measured in seconds, and directly translates to a delay which is very noticeable to the user of the device. These delays severely degrade the user experience and are widely recognised to be unsatisfactory. The delays are not uncommon because, in the worst case, updating of the TFT profile can occur every time a new application socket is connected.

It is therefore an object of the present invention to substantially alleviate or possibly eliminate much of the delay incurred in renegotiating or modifying the parameters that determine the characteristics of the network communication link.

According to a first aspect of the present invention there is provided a method of providing connection of a computing device to a network wherein attributes are passed by the computing device to the network for specifying characteristics required of the connection and the attributes are selected in dependence upon future requirements for the computing device over the connection.

According to a second aspect of the present invention there is provided a computing device arranged to operate in accordance with the first aspect. According to a third aspect of the present invention there is provided an operating system for enabling a computing device to operate in accordance with the first aspect.

Embodiments of the present invention will now be described, by way of further example only, with reference to the accompanying drawings in which

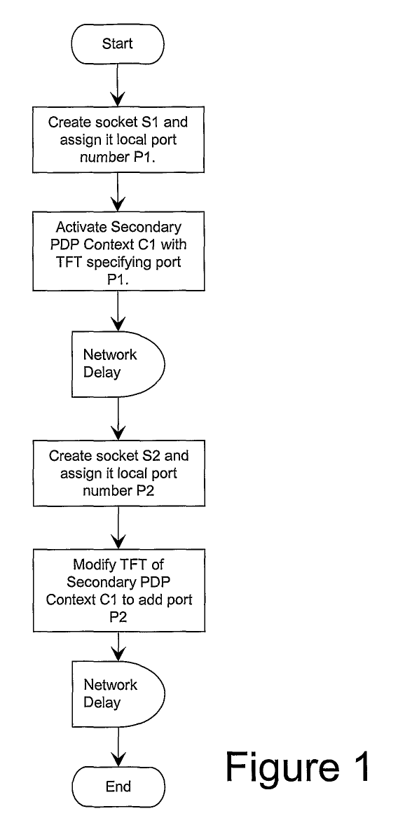

FIG. 1 shows a known traffic flow template profile; and

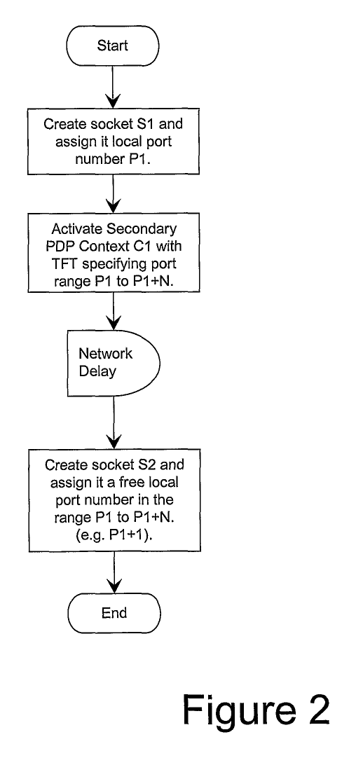

FIG. 2 shows 1 shows a traffic flow template profile according to the present invention.

A first implementation of the present invention comprises a mobile telephone (the Mobile Station) connected to a 3GPP network and implements an enhancement to the way that a mobile station specifies a TFT when a Secondary PDP Context is first activated.

Section 15.3 of the 3GPP TS 23.060 document (referred to above) outlines the format of a TFT as follows:
“A TFT consists of from one and up to eight packet filters, each identified by a unique packet filter identifier . . . a TFT is always associated with a PDP context during the Secondary PDP Context Activation procedure . . . by means of the MS-Initiated PDP Context Modification procedure any TFT can be modified . . . during the modification of a TFT, one or more existing packet filters can be modified or deleted, or a new packet filter can be created.
Each valid packet filter contains a unique identifier within a given TFT, an evaluation precedence index that is unique within all TFTs for one PDP address, and at least one of the following attributes:
   Source Address and Subnet Mask.
   Protocol Number (IPv4)/Next Header (IPv6).
   Destination Port Range.
   Source Port Range.
   IPSec Security Parameter Index (SPI).
   Type of Service (TOS) (IPv4)/Traffic class (IPv6) and Mask.
   Flow Label (IPv6).”

The present invention is predicated on the basis that when the packet filters comprising the TFT of each Secondary PDP Context are specified, they are specified in such a way that they cover not only the immediate IP flow or socket that needs to be assigned to the Secondary PDP Context, but also cover currently non-existent but anticipated future IP flows or sockets that are likely to be opened by applications for that Secondary PDP Context.

In a device operating according to the present invention, a TCP/IP stack in the Mobile Station arranges for the local port number of all its IP flows to be allocated from a particular group of local port numbers. It also ensures that the range of ports included in a TFT packet filter for any secondary PDP Context is specified in such a way as to cover its own group of local port numbers, even though some of these port numbers may as yet be unused. Consequently, with the present invention, the TFT of a Secondary PDP Context does not need to be modified until the pre-reserved range of ports for the TFT packet filter concerned is exhausted. Hence, it can be seen that the present invention substantially alleviates the processing overhead involved in opening additional ports for each TFT packet filter.

This is in contrast to the technique of changing the TFT each time an application opens a socket, and adding an additional IP flow to the corresponding Secondary PDP Context requires time consuming signaling updates. This invention eliminates this overhead once for each local port number in the specified range, with a consequent improvement in the responsiveness of the Mobile Station and the resulting user experience.

The improvement this invention offers over the technique of changing the TFT each time an application opens a socket can clearly seen by reference to FIG. 1, where an apparatus without this invention can be seen to incur an extra network delay when an additional port needs to be used.

In an alternative embodiment, more complex applications of this invention, which anticipate more than just the port ranges available in a TFT packet filter, are envisaged. These are able to provide even more functionality and therefore make additional improvements to the latency of 3G data connections on computing devices.

It is widely recognised that patterns of usage of connected computing devices are generally not random, but instead replicate commonly undertaken tasks. The ability to store the details of such tasks, either automatically or manually, can make potentially complex and error-prone operations easier from a user perspective. For example, saving of commonly used or recently used web sites as ‘Favourites’, with automatic filling in of corresponding URLs, makes web browsers easier to use, while the use of address books performs the same function for email applications.

By making use of recent IP usage data, it is possible for a computing device to store details of TFT packet filters which are tailored for future use with specific applications or data, such as with specific network addresses, or ‘Favourites’ data. Hence, in this embodiment of the invention the TFT packet filter information is arranged to include all the appropriate attributes from the 3GPP specifications listed above, and not merely the range of port addresses required. For example, the TFT packet filter profiles appropriate for use with the streaming of media services such as iTunes™ or Napster™ would, with this invention, be very different to those associated with an information service such as the BBC News. Storage of TFT packet filter profiles along with the addresses of respective sites (either in a Favorites list or associated with specific IP address ranges) enables the data to be retrieved (as appropriate) on subsequent access to specific IP addresses, or subsequent use of Favourites data, without the need to update the respective packet filter profile for a site. In an ideal case where the IP addresses are known or can be predicted sufficiently reliably in advance, only one single PDP context set up would be needed, and no subsequent modification would be required.

TFT profiles can also be arranged so that they are associated with particular applications. As an example, the specific TFT packet filter requirements of an email application programme may easily be retrieved when the application is loaded.

Depending on the accessibility of the appropriate API (application programming interface) in any specific computing device, this packet filter information may be stored either by the operating system for the computing device, or by individual applications, or even internally by the communications stacks.

Therefore, it can be seen that by the use of this invention, a smart networked computing device is provided with improved operating performance by saving attribute information relevant to the requirements of tasks it has performed previously.

The present invention is, therefore, considered to provide significant advantages over the known art, including:
reducing delays when starting up an application, or during application execution, where this involves use of 3G networks, therefore improving the user experience.
reducing both the time and the transmission overhead taken to access network services, reducing power consumption both on the device and also in the network. This is considered to be particularly beneficial in resource constrained Mobile Stations, such as mobile phones, where the operation time obtainable from the relatively small internal battery source is of paramount importance.

Although the present invention has been described with reference to particular embodiments, it will be appreciated that modifications may be effected whilst remaining within the scope of the invention as defined by the appended claims.

1. A method of providing connection of a computing device to a network wherein
a. attributes are passed by the computing device to the network for specifying characteristics required of the connection; and
b. the attributes are selected in dependence upon future requirements for the computing device over the connection.

2. A method according to claim 1 wherein the network comprises a wireless network and the computing device comprises a mobile station.

3. A method according to claim 2 wherein the wireless network conforms to the specifications laid by 3GPP.

4. A method according to claim 2 wherein the wireless network conforms to the specifications laid by 3GPP2.

5. A method according to claim 1 wherein the computing device and the network communicate using Internet Protocols and wherein the attributes are passed by the computing device to the network in the form of packet filters.

6. A method according to claim 1 wherein the attributes are selected in dependence upon network resources parameters comprising any one or more of:
a. connections to IP Addresses
b. port ranges used by applications
c. port ranges allocated from within a larger group of ports previously reserved for use by the Internet Protocol or other communications stack
d. security constraints imposed either by the network or device
e. type of service
f. quality of service.

7. A method according to claim 1 wherein the attributes are selected in dependence upon any one or more of:
a. the opening of a network connection by an application
b. the opening of a network connection to an address
c. the invocation of a stored link or Favourite item in an application.

8. A method according to claim 1 wherein patterns of network usage by applications and/or protocol stacks and/or other device components are used for determining network requirements for those components.

9. A method according to claim 8 wherein the patterns are determined in response to user input and stored in the device during operation.

10. A method according to claim 9 wherein the user input comprises
a. the bookmarking of a location
b. the generation of a shortcut
c. the storage of a Favourite site.

11. A method according to claim 9 wherein the user input for triggering the determination of the patterns is selected by the user.

12. A method according to claim 8 wherein the patterns are determined automatically and stored in the computing device at run time.

13. A method according to claim 8 wherein the patterns are incorporated in the device at build time of the device.

14. A computing device arranged to operate in accordance with a method as claimed in claim 1.

15. An operating system for enabling a computing device to operate in accordance with a method as claimed in claim 1.
